(19) United States
(12) Patent Application Publication
(10) Pub. No.: US 2009/0132338 A1
(43) Pub. Date: May 21, 2009

(54) METHOD AND SYSTEM FOR IMPROVEMENTS IN OR RELATING TO SALES AND MARKETING PRACTICES

(75) Inventors: Peter KEELING, Belfast (GB); David SMART, Moira (GB)

Correspondence Address: FOLEY AND LARDNER LLP;SUITE 500, 3000 K STREET NW, WASHINGTON, DC, 20007, US

(73) Assignee: Diaceutics

(21) Appl. No.: 11/943,539

(22) Filed: Nov. 20, 2007

(51) Int. Cl. G06F 17/30

(52) U.S. Cl. 705/10

(57) ABSTRACT

A method of identifying whether a first product should be sold or marketed, associated with a predetermined diagnostic, based on the impact of the predetermined diagnostic on one or more other products which are similar to the first product in one or more respect, and where not all the other products have experienced the predetermined diagnostic. The method comprises the following steps: determining one or more marketing factors associated with the product which are potentially influenced by the predetermined diagnostic; determining a scoring scheme associated with the or each marketing factor for deriving a score associated with the first product; comparing the score of the first product with a score associated with the said one or more other products; identifying the one or more other products that have a score within a predetermined threshold of the score for the first product, to identify one or more possible matching other products; and determining whether the one or more possible matching products have experienced the predetermined diagnostic in order to determine whether the first product should be sold or marketed, associated with the predetermined diagnostic.

### FIELD OF THE INVENTION

The present invention relates to improvements in or relating to sales and marketing practices. In particular, the invention relates to an improved method and apparatus for comparing different clinical, regulatory, sales and marketing criteria to enable improved sales and marketing practices.

### BACKGROUND OF THE INVENTION

Marketing is a developing science where there are many practices but where aspects of standardizing, monitoring, controlling etc. the processes are often inadequate. In some industries, this does not have a particularly detrimental effect, although some standardization and control would be beneficial. However, in the pharmaceutical industry standardization and control of marketing can have a much more important role. Without standardization and control it is possible that patients can be given treatments of the wrong type or in the wrong amount, or misinformed in relation to particular therapies and medication.

While the top pharmaceutical companies have made investments in Research and Development in biomarkers and genetics to aid drug selection and clinical trials, only a few have taken targeted therapies all the way through the development pathway and onto the market. A key question for those companies who have not yet acquired this level of experience is, “What exactly are the decision processes essential to guide early commercial commitment, i.e. the commitment to market a therapy alongside a theranostic, in Personalized Medicine?”

The use of diagnostic tests in relation to a particular therapy is becoming increasingly common. A diagnostic test can identify: a particular disease state; the candidate for a particular therapy and candidates to be excluded from a particular therapy. A test may enable adjustment of the dosage of the therapy to a level appropriate for an individual patient. Additionally, a diagnostic test can indicate the degree of surveillance required during a particular therapy and monitor positive (e.g. efficacy) and negative effects of the therapy or any other appropriate criteria.

In some circumstances, certain tests are mandated by regulatory authorities. For example, a healthcare provider is required to test a patient for over-amplification of the HER-2 marker before initiating treatment with Herceptin.

In other situations tests are not mandated by a regulatory authority but may nonetheless be performed as an adjunct to the therapy. Such a test can provide healthcare providers with more information upon which to base their choice of therapy, dosage, level of patient surveillance etc.

At present the pharmaceutical industry uses non-standardized and subjective clinical utility cut-off points to decide whether or not a therapy should be marketed without a test under a “one size fits all” marketing model.

Alternatively, trials of a particular therapy may indicate that it has only limited clinical utility in the general population resulting in said therapy not reaching the market. However, such a therapy may be highly effective in a sub-group of the general population and use of a test would identify those patients in this sub-group thereby enabling marketing of the therapy to the group for whom it will be effective.

In general, at the conclusion of phase 3 trials of a certain therapy it will be known, with a high degree of certainty, whether or not a test is the optimum solution for marketing a therapy. However, the end of phase 3 trials of a therapy is not the ideal time for assessing the need for commercialization of the test in association with the therapy. This is required in a pre-phase 3 timeframe due to the timescales required in putting in place appropriate testing and the requirements to “test the test” both in terms of its clinical performance and its acceptance in the marketplace.

Another problem that exists with current methods is the fact that their strategies are inconsistent and not standardized across all product ranges either in the same company or in the same market. This can create subjective decision-making in respect of significant multi-million dollar investment commitments.

In addition, the real-life experiences of therapies used by patients often result in retrospective mandating of warnings of adverse effects. These are commonly known as “black box” warnings. This can have detrimental impact on the commercial attractiveness of a particular therapy and can alter the dynamics of the test/no test decision.

A potential return on investment advantage in combining an existing test with a therapy and a method of assessing the degree of advantage has been described in co-pending US application of common date and common assignee entitled “A business method for enabling personalized medicine” (herein included by reference). Whilst this has provided a number of advantages it does not support changes in circumstances pertaining to the dynamics of the test/no test decision during the lifetime of the therapy.

### OBJECTS OF THE PRESENT INVENTION

One object of the present invention is to provide a method and apparatus which overcomes at least some of the problems associated with the prior art.

A further object of the present invention is to identify a method of assessing the likely requirement for a test to support a therapy that is being placed on the market in sufficient time as to enable development and marketing of such a test prior to launch of the therapy.

Another object of the present of invention is to provide a means to model, at a pre-investment stage, the trade-off between a personalized therapy with a test strategy and a non-test strategy subjected to potential post-marketing adverse events.

It is still further an object of the present invention to provide a means of removing subjectivity in the determination of the test/no test marketing strategy and to provide a consistent method across a number of therapies to support the test/no test decision making process.

The present invention provides a number of advantages over current art which should be apparent from the following description.

### SUMMARY OF THE PRESENT INVENTION

According to one aspect of the present invention there is provided a method of identifying whether a first product should be sold or marketed, associated with a predetermined diagnostic, based on the impact of the predetermined diagnostic on one or more other products which are similar to the first product in one or more respect, and where not all the other products have experienced the predetermined diagnostic. The method comprises the following steps: determining one or more marketing factors associated with the product which are potentially influenced by the predetermined diagnostic; determining a scoring scheme associated with the or each marketing factor for deriving a score associated with the first product; comparing the score of the first product with a score associated with the said one or more other products; to identify one or more possible matching other products; and determining whether the one or more possible matching products have experienced the predetermined diagnostic in order to determine whether the first product should be sold or marketed, associated with the predetermined diagnostic.

There may be a marketing and selling advantage to a pharmaceutical company if a test is produced or marketed in conjunction with a therapy to which the test relates. Thus, in one specific non-limiting embodiment of the invention, the product is a pharmaceutical and the predetermined diagnostic is some form of test which determines suitability of the pharmaceutical for use in a given patient. Thus, the invention identifies a method of assessing the likely requirement for a test to support a therapy being placed on the market (as opposed to use of a test in therapy clinical trials only). This therapy may already be in existence or may be a new therapy.

The invention also provides a way of assessing the likely requirement for a test to support a therapy being placed on the market prior to major investment being made in the development and commercialization of the test.

Furthermore, the method permits examination of the effects of changes in the circumstances pertaining to the therapy in respect of the test/no test decision during the lifetime of that therapy. Also the invention provides a way of standardizing the decision making relating to the inclusion/exclusion of a test across the industry and across teams within the same pharmaceutical company through use of a standardized method

Further advantages of the present invention are: simplicity (to facilitate buy in and understanding by those responsible for strategic decision making), grounding of the metrics used as a basis for decision making in real world numbers and a lack of bias towards any one particular factor used in the decision making process.

Use of case based reasoning (CBR) enables analysis of the effects of a number of factors on the outcome(s) of particular scenarios or systems under study. The effects of these factors may be examined by correlating a metric pertaining to the factors being considered (input factors) to a metric pertaining to the outcome being considered in a number of cases held in a database. These effects may then be used to predict the outcome of an unknown case from an analysis of the input factors.

It is an advantage of the present invention that the selection of factors enabling a clear determination of the test/no test decision is based on known cases, and is made at an appropriate commercial stage of selling and for marketing a drug. It is also an advantage of the present invention that the grading and weighting of the factors enables a clear determination of the test/no test decision based on known cases. It is still further an advantage of the present invention that the method of combining the factors enables selection of a clear threshold for the determination of the test/no test decision based on known cases.

It is another advantage of the present invention that an effect of changing one or more of the factors may be modelled to predict changes in the outcome (e.g. the test/no test decision).

### BRIEF DESCRIPTION OF THE DRAWINGS

Reference will now be made, by way of example, to the accompanying drawings, in which:—

FIG. 1 is a graph showing the decile classing of a drug in accordance with one aspect of the present invention, by way of example.

FIG. 2 is a graph for showing potentially treatable patients, which is used to demonstrate certain aspects of the present invention, by way of example.

FIG. 3 is the diagram indicating the influence of drug tests, in accordance with one aspect of the present invention, by way of example.

FIG. 4 is a table of the raw and normalized values of input factor used in calculations for each drug, in accordance with one aspect of the present invention, by way of example.

FIG. 5 is the table of the comparison of OFTI and the OFTI squared values for all the drugs in FIG. 4, in accordance with one aspect of the present invention, by way of example.

FIG. 6 is an OFTI graph of the drugs shown in FIGS. 4 and 5, in accordance with one aspect of the present invention, by way of example.

### DETAILED DESCRIPTION OF EMBODIMENTS OF THE PRESENT INVENTION

Case based reasoning (CBR) can be used to examine the effects of a number of factors relating to a test used in conjunction with a particular therapy. The factors include but are not limited to labeling, excluded population, severity and sales. Labeling relates to the requirement of a regulatory authority for use of a test and details on how it may be implemented. Excluded population relates to adverse side-effects brought about by a therapy in a certain population, that should ideally be excluded from use of the therapy because of those adverse effects. Severity is an indication of the severity of any likely side-effect in utilizing the therapy. Sales relates to the current and projected yearly sales and market position of the therapy. These four factors are non limiting examples of factors which may be considered in selling or marketing a drug. There may be many other factors that are equally relevant to the present invention for functions other than selling or marketing, or for products other than drugs.

Having identified the factors that are relevant to the particular circumstances, quantification or grading of values for the factors is determined. For each factor a variable is assigned (for labeling: L; for excluded patient population: E; for severity: S; for sales: M) and a number assigned to that variable to give an indication of the grading of that factor for a particular therapy.

Labeling is defined as the package insert of the therapy as cleared and approved by the relevant regulatory authority (e.g. FDA). “Raw” values are then produced by stratification of the labeling requirements according to the following rules.
L=4: does the labeling mandate use of the test in indications for use?
L=3: does labeling recommend a test or indicate a condition that should be monitored as either a pre-requisite to use or for monitoring during use?
L=2: does labeling indicate a condition that can be tested prior to or during use?
L=1: does labeling mention a test or condition in the context of the therapy?

Obviously, if this factor returns a score of 4, then the drug

automatically requires a test. The excluded patient population (E) is calculated as 1 minus the percentage of patients on which the drug will work, divided by a hundred. For example Herceptin works on 25% of patients therefore E equals 1-0.25 which equals 0.75. Values of E can be derived from the approved package insert of the various therapies or from clinical literature etc.

“Raw” values of S are produced by stratification of the labeling requirements according to the following rules:
S=4: indicates a black box warning on a condition that can be tested for.
S=3: indicates a high rate of serious side-effects on a condition that can be tested for.
S=2: indicates a low rate of serious side-effects on a condition that can be tested for.
S=1: indicates a black box warning on a condition that would not ordinarily be tested for (e.g. ethnicity).
S=0.5: indicates a high rate of serious side-effects on a condition that would not ordinarily be tested for.

The rates and severity may be defined by the regulatory authority and may be included in a package insert for the given therapy.

Raw values for M are taken from the value of yearly sales in $M for a variety of therapies. These values may be taken from company reports or other published sources.

A number of other methods of assigning or deriving values for the input factors may be considered and the above mentioned list is not meant to limit the scope of the invention in any way.

The next stage is to determine normalized values for the input factors. For those factors where a normalized value is already used (e.g. labeling and severity) the value is used without modification. For the excluded population the value was multiplied by 4 (i.e. value range 0-4) to produce a similar range to that for L. Similarly, the values for sales are stratified by deciles given in, for example, an analysis of Grabowski and Vernon (1998) and then values assigned as follows:

0=Top Decile (M>$M2600)

1=Between top and 2nd decile ($M 950<M<$M 2600)

2=Between 2nd decile and mean ($M 500<M<$M 950)

3=Between mean and median ($M 130<M $M<500)

4=<median (M<$M 130)

The sales figures used to calculate these deciles may be changed as new figures become available. There may be other ways of deriving values for these or other input factors relevant to the outcome and of normalizing such values. Such methods are considered to be within the scope of the current invention.

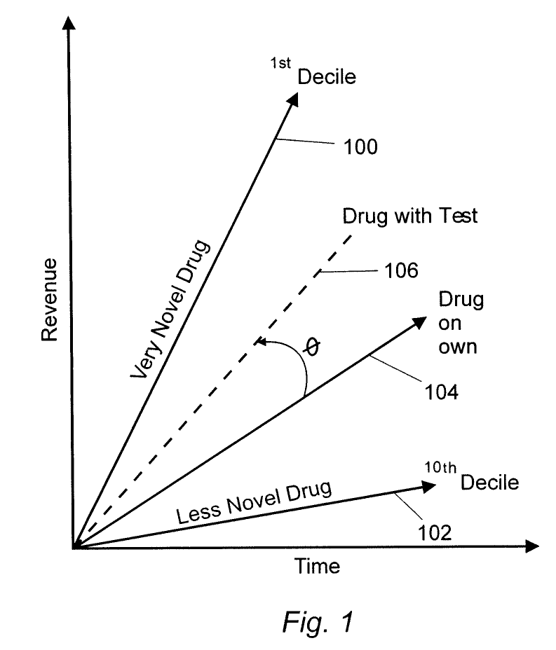

By way of example in the present invention, a determination is made as to at which phase of clinical trials co-marketing of a test associated with the drug should occur. The co-marketing of a test is a particular diagnostic. Other diagnostics may be used in this invention, but for the present example co-marketing of a test is used to demonstrate the present invention. By using a prediction model (for example as described in co-pending patent application entitled “Medical Revenue Prediction Model” (Keeling, 8 Sep. 2006) incorporated herein by reference) the decile class of a given drug can be determined and compared with that of other drugs when co-marketed with a test. FIG. 1 shows a graph showing revenue against time for different deciles classifications of drugs and can be used to demonstrate the sales factor indicated above. The first decile 100 relates to the profile for a very novel drug, whilst at the 10th decile 102 relates to a much less novel drug. The revenue profiles 104 and 106 show the difference relating to marketing a drug on its own (104) and marketing the drug with the test (106). The decile classing of the drugs looks at the sales patterns of the drugs as illustrated, either with or without a test. From the graph it can be seen that marketing the drug with an associated test is likely to provide greater revenue.

In the same example, i.e. evaluating the effect of co-marketing of a test with a particular drug, other measures can also be used. For example, the number of potentially treatable patients lost by not co-marketing the drug and the test can be evaluated.

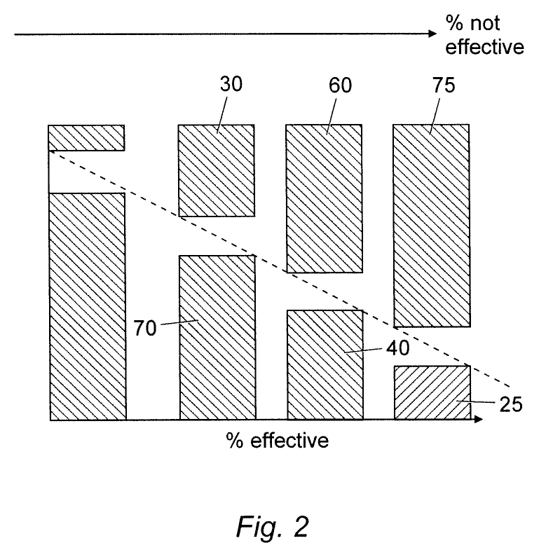

The pharmaceutical industry often decides whether or not to co-market a drug and test on the basis of the percentage of patients for whom the drug was found to be effective. This may constitute another factor for comparison. If the drug is 70% effective a pharmaceutical firm would not normally consider the need to market a test to identify those patients for whom it will be most effective. However, if the drug is only 25% effective it would be normal for a test to be included. There are no fixed rules for determining the threshold at which co-marketing is the better option. However, this allows comparison between one drug and another to determine where the threshold might be best positioned. In accordance with FIG. 2 the percentage of effectiveness of a drug and an associated test is shown and may be used to determine whether co-marketing a test is a good choice or not.

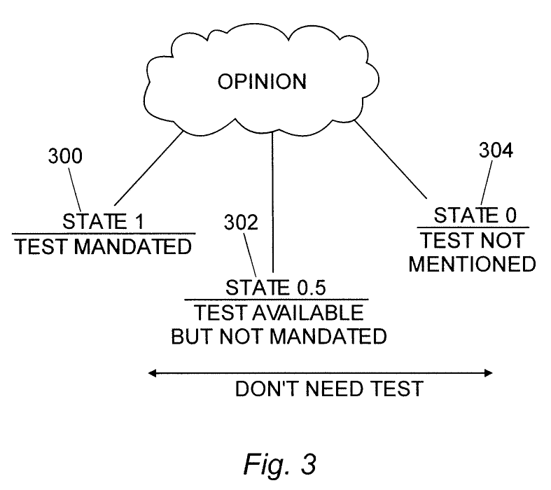

Other factors may also be used to measure or evaluate the comparative score between one drug and another. For example, a comparison of the number of patients experiencing adverse effects from the drug may be made. This is useful because the FDA typically categorizes patients according to whether or not they are likely to experience an adverse effect. The present invention uses this parameter to determine whether or not the presence of adverse effects are sufficient to warrant a test to deselect certain patients from a given drug regime. Also, a regulator's position regarding drug labeling may also dictate whether or not a test should be mandated or not. Referring to FIG. 3, the present invention essentially divides the regulator's opinion into three states. In the first state (300) the regulator may mandate that the drug be co-marketed with a test in which case the test/no test decision is effectively removed from the drug sponsor and placed in the hands of the regulator. In the second stage 302 the requirement for a test may not be specifically mandated. In the third stage 304 the regulator may indicate that there is no test that needs to be mentioned.

The method may then be incorporated within a planning program, to underpin the process and above mentioned steps. An example of such a planning program is disclosed in U.S. Ser. No. 11/625,242, incorporated herein by reference.

Returning now to the four factors L, E, S and M, the combination of factors for a given therapy may be analyzed in the following way:
Straight summation (i.e. L+E+S+M, sum method)
Sum of all squares (i.e. L²+E²+S²+M², sum of squares method)
Sum of 1 square to investigate the effect of weighting one factor over the others
i.e. L²+E+S+M (L2 method)
L+E²+S+M (E2 method)
L+E+S²+M (S2 method)
or L+E+S+M² (M2 method))

Whichever method is used, the variable derived from a combination of normalized input factors is called the opportunity for test index (OFTI).

There may be other ways of combining the normalised values for the input factors to produce a figure relevant to the outcome. The methods described here are examples and not meant to limit the scope of the invention. Other examples include weighting calculation, stratification according to levels, subtraction from a set value etc.

A database of therapies, some of which are associated with a test use and some of which are not, is examined and combined factor values are derived as detailed above. Mean values for therapies with an associated test are compared to those without, for all combination methods detailed above.

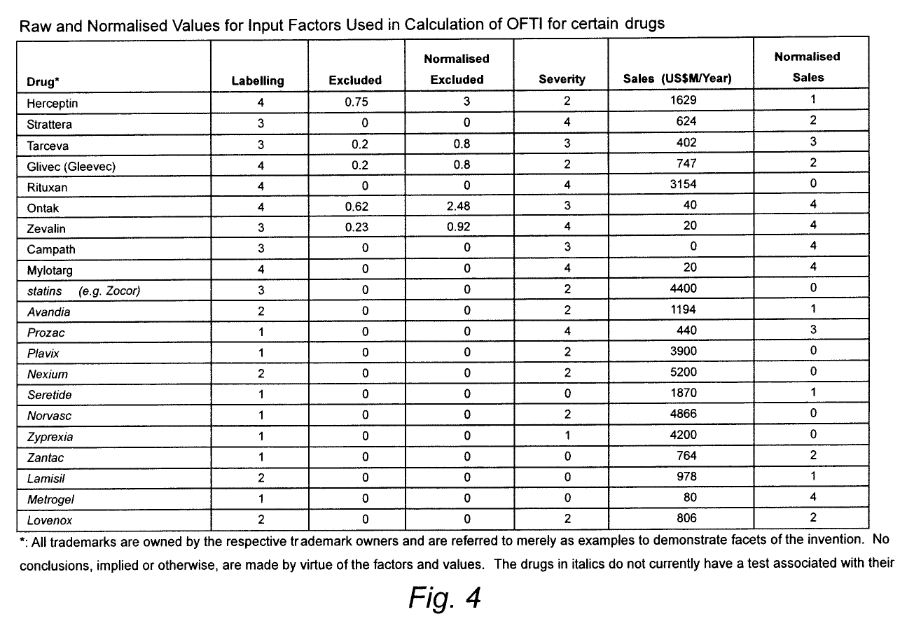

The drugs considered in the analysis and raw values for the input factors, mentioned above, are listed in the table in FIG. 4.

In general, the combination methods produce mean values for therapies associated with a test that were higher than the mean value for therapies without an associated test. The difference between the mean values is highly statistically significant (t-test, p<<0.01). The sum of squares method gave the largest difference between mean values for therapies with a test and mean values for therapies without.

A cutoff of mean value with test−2*(Standard deviation {value with test} was tested for its ability to discriminate between the two groups of cases. Use of such a cutoff for all combination methods tested gave 100% sensitivity (i.e. correct identification of all therapies with an associated test), however the M2 and E2 methods produced a significant loss in specificity (i.e. of therapies without a test were incorrectly identified as having a test).

A cutoff of mean value without test+2*(Standard deviation {value without test}) was also tested, however the S2 and M2 methods were less successful in identifying therapies with an associated test.

A cutoff set midway between the mean values for therapies with a test and those without, again indicated less sensitivity with the S2 and M2 methods.

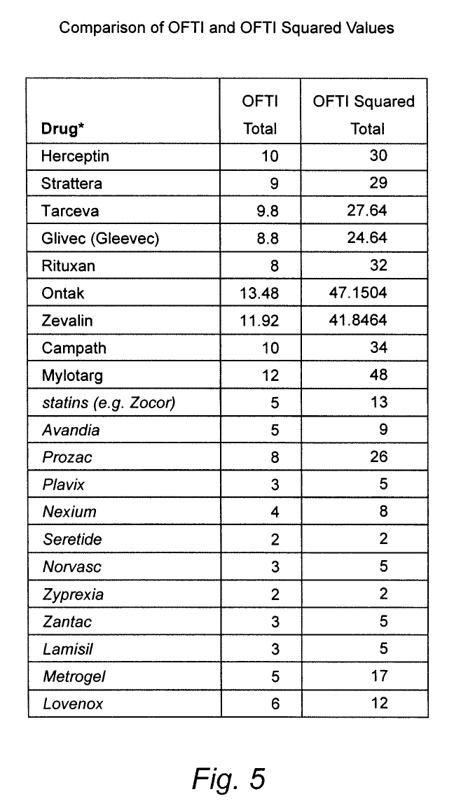

While most combination methods, and selection of cutoffs gave acceptable levels of sensitivity and specificity, the sum of squares method with a cutoff of mean value of therapies with a test−2*(Standard deviation {value with test}) is a preferred method as it produces maximal sensitivity, high specificity and the largest separation between values for therapies with a test compared to those without. A comparison chart of results for the sum method and sum of squares method is shown in the table in FIG. 5. Methods for the selection of cutoff described herein are examples. There may be other ways of calculating suitable cutoff points and exclusion of such methods is not meant to limit the scope of the invention for example.

Use of any cutoff value has to take account of the value of the labeling (L) factor; if this indicates that a test is mandated then a test is required regardless of the value of the other factors.

Certain drugs not generally associated with a test, were identified as ones which should be associated with a test.

Use of a suitable database for known cases enables an integrated or separate computer based tool to extract relevant data and enables the database of known cases to be updated with new cases to refine the overall method or to permit examination of particular therapeutic classes e.g. anti-neoplastic drugs.

With the calculations for test factor set up in a suitable spreadsheet format (e.g. Microsoft™ Excel), it is possible to model the effect of changing the circumstances of the therapy on the requirement for a test.

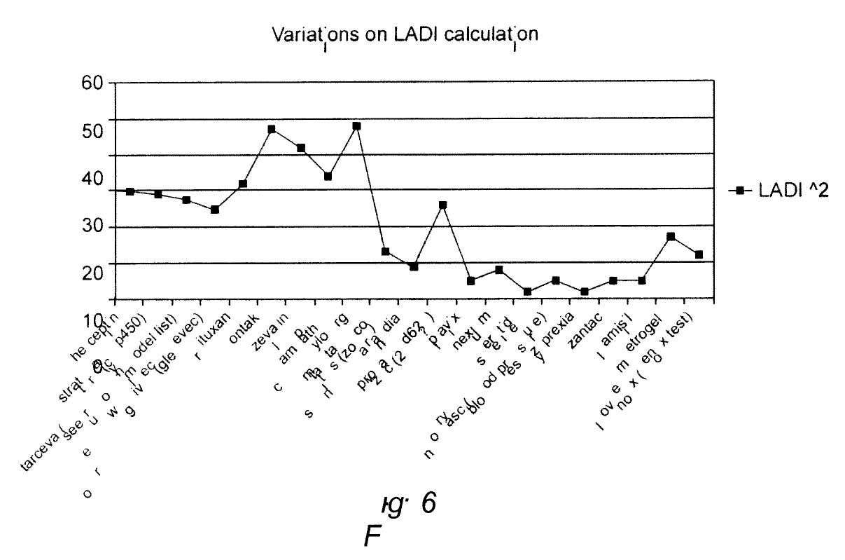

FIG. 6 shows an OFTI graph to show the OFTI squared totals shown in FIG. 5 in order to illustrate where certain drugs that are not generally associated with a test should actually be associated with a test.

The following examples give an indication of the use of the present invention:

Avandia currently has a side-effect severity level assessed as 2. However, if it were to receive a “black box” warning on increased risk of congestive heart failure, then this would change to 4. The test factor (sum of squares method) would change from 9 (below the cutoff) to 21 indicating that a test may be appropriate for use with this therapy if the “black box” warning was implemented.

Campath has been launched only recently (therefore sales are low). The test factor of Campath (sum of squares method) is calculated as 34 indicating that a test is appropriate with this therapy. However, as sales build and assuming no other factor changes, a situation could arise where a test may be much less appropriate. For example, if sales of Campath reach the top decile as defined by Grabowski and Vernon (1998), then the test factor becomes 18, below the cutoff, and the requirement for testing is much less. This may present an advantage if the test is costly and the company marketing the pharmaceutical is subsidizing the cost of the test in order to facilitate marketing of the drug.

It will be appreciated that this method gives a number of key advantages over prior art systems and current methodologies.

It will be obvious to one with ordinary skill in the art that the invention described above may be implemented in a variety of ways without departing from the scope of the invention. For example, the method need not be limited to determining whether or not a drug should be sold with a test. Other diagnostics may be used instead, for example determining whether or not a drug should be sold with advertising, governmental approvals, or any other appropriate diagnostic. Similarly, the invention does not need to be limited to drug sales, marketing and position within class, but can instead include other factors where a number of marketing factors may influence the sales and marketing and position of a brand. Any such variations are not to be regarded as a departure from the scope of the invention and as such, all such modifications are intended to be included within the scope of the invention.

It will further be clear to one of ordinary skill in the art that there are a number of ways of quantitating, grading or stratifying the magnitude of the input factors used. How this is done should not give undue weight to one factor or particular set of factors in order to exclude bias. It will further be appreciated that there are a number of ways of combining the factors in order to give a quantity or grading which can then be correlated to the presence or absence of a test in the marketing of a therapy by analysis of known cases. Such methods may be used to accentuate the differences between test and no test cases and enable the selection of a threshold for the quantity or grading which can then be used to determine whether a test is appropriate for a given therapy or not (unknown case) from consideration of the input factors used in analysis of the known cases.

1. A method of identifying whether a first product should be sold or marketed, associated with a predetermined diagnostic, based on the impact of the predetermined diagnostic on one or more other products which are similar to the first product in one or more respect, and where not all the other products have experienced the predetermined diagnostic, the method comprising the steps:
determining one or more marketing factors associated with the product which are potentially influenced by the predetermined diagnostic;
determining a scoring scheme associated with the or each marketing factor
combining scores from the scoring scheme for the or each marketing factor to produce a final value associated with the first product;
comparing the score of the first product with a similarly-calculated score associated with the said one or more other products;
comparing the score for the first product with that of other products with similarly calculated scores, to identify one or more possible matching other products;
determining whether the one or more possible matching products have experienced the predetermined diagnostic in order to determine whether the first product should be sold or marketed, associated with the predetermined diagnostic.

2. A method according to claim 1, further comprising applying the predetermined diagnostic in final marketing or selling of the first product.

3. A method according to claim 1, further comprising deriving a score associated with the one or more other products and storing the score associated with the one or more of the products in a database.

4. A method according to claim 1, further comprising normalizing the scores before comparing the scores in the first product with those of the other products.

5. A method according to claim 4, wherein the step of normalizing the scores comprises applying one or more mathematical operations to the scores such operations being selected from a group including but not limited to multiplication by a weighting factor, stratification according to set levels, subtraction from a set value.

6. A method according to claim 1 wherein an aggregate score is produced from the normalized scores by applying one or more mathematical operations such mathematical operations being selected from the group including, but not limited to summation of factors; summation of squares of factors; weighted summation of squares of factors; summation of one squared factor and other non-squared factors;

7. A method according to claim 1 wherein the score calculated for a given product such as a test value is compared to a plurality of scores derived from calculation of similar factors for other products such as a comparison value.

8. A method according to claim 7 wherein the comparison method may selected from a group including but not limited to comparison of magnitudes of test value and mean of comparison values, comparison of test value with an element of the variance of the comparison values for example mean +/−2 standard deviations, comparison of the test value in relation to comparison values from two groups of products which differ in their requirement for the predetermined diagnostic.

9. A method according to claim 1, further comprising selecting the first product to be a pharmaceutical.

10. A method according to claim 1, further comprising selecting the one or more other products to be a pharmaceutical.

11. The method according to claim 1, further comprising determining whether the first product should be marketed or sold with a test associated therewith.

12. A method according to claim 1, further comprising selecting the factors from the list including but not limited to regulatory requirements, frequency of side-effects, the severity of side effects, effectiveness of the product, product revenues, positive attributes of the product, negative attributes of the product.

13. A computer program comprising instructions for carrying out the method according to claim 1, when said computer program is executed on a computer system.

14. A computer program comprising instructions for carrying out the method according to claim 3, when said computer program is executed on a computer system.

15. A computer program comprising instructions for carrying out the method according to claim 4, when said computer program is executed on a computer system.

16. A computer program comprising instructions for carrying out the method according to claim 5, when said computer program is executed on a computer system.

17. A computer program comprising instructions for carrying out the method according to claim 6, when said computer program is executed on a computer system.

18. A computer program comprising instructions for carrying out the method according to claim 7, when said computer program is executed on a computer system.

19. A computer program comprising instructions for carrying out the method according to claim 8, when said computer program is executed on a computer system.

20. A method of storing data collected in accordance with claim 1, the method comprising storing data related to products, marketing factors, scores and final values for comparison in a database; updating the stored data based on changes to the marketing factors so as to update the scores and final values for comparison.
